(19) United States
(12) Patent Application Publication
(10) Pub. No.: US 2004/0193677 A1
(43) Pub. Date: Sep. 30, 2004

(54) Network service architecture

(76) Inventors: Shaul Dar, Tel Aviv (IL); Eden Shochat, Ra'ananna (IL); Geva Solomonovich, Nes Zionna (IL)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/395,801

(22) Filed: Mar. 24, 2003

(51) Int. Cl. G06F 15/16

(52) U.S. Cl. 709/203

(57) ABSTRACT

A system for use in a network that includes a plurality of clients and a plurality of servers configured to provide services includes at least one interface configured to communicate with the clients and the servers, a memory that contains computer-readable and computer-executable instructions, and a processor coupled to the at least one interface and to the memory and configured to read and execute the instructions, the instructions being configured to cause the processor to: analyze a client-service communication, received from one of the clients by the at least one interface, for a client identifier associated with the client originating the client-service communication and for a virtual service identifier associated with an intended service of the client-service communication; perform network address translation on the client-service communication to produce a modified client-service communication, the translation including translating the virtual service identifier to an actual service identifier of the service and translating the client identifier to a virtual source identifier; and transmit the modified client-service communication via the at least one interface toward the intended service.

### FIELD OF THE INVENTION

The invention relates to network architecture and more particularly to a network architecture with selectively routing of managed services.

### BACKGROUND OF THE INVENTION

Network servers provide a wide array of services to clients connected to the servers via a network. The servers run programs to provide services such as web content, FTP, email, e-commerce, printing, graphics, audio and/or video services, etc. Client requests are relayed via the network to a server that contains the program to provide the service needed by the request. Different servers typically store different sets of programs to provide different sets of services.

Referring to FIG. 1, a typical client-network-server configuration 500 includes clients 502, a network 504, and several servers 506. The servers 506 include software programs that use stored data for providing services. The clients 502 may be applications servers, end user workstations, etc., and may access the servers 506 via the network 504 that is typically a packet-switched network, e.g., the Internet. Access to one or more of the services provided by the servers 506 may be limited, e.g., by the servers 506 requiring a user of the client 502 to provide a login ID and a password.

In network communications, it is often desirable to conceal the actual identifier (address and/or port number) of servers associated with services. To help conceal the actual identifier of a service, the service may be identified using a virtual service identifier that comprises a virtual network address and/or a virtual port number. This virtualization can help control access to servers and allow for management of service requests. For example, multiple servers may provide the same service, and communications directed to a service may be selectively routed to any of the possible servers, e.g., for load balancing purposes or because of a predetermined association of a particular client and a particular server, etc. Where virtualization is used, network address translation (NAT) can be performed in a router that lies between the server and the client. As used here, NAT includes translation of port numbers as appropriate, and thus includes what is sometimes called NAPT (network address and port translation). All incoming information (e.g., a request or data) sent toward the service, and every response by the server that received the information, is operated on by the router to translate the publicly-available service identifier for the service to an actual identifier (for information coming in to the server) or vice versa (for information from the responding server). Many different services can be provided by the server and the server can take a variety of forms.

### SUMMARY OF THE INVENTION

In general, in an aspect, the invention provides a system for use in a network that includes a plurality of clients and a plurality of servers configured to provide services. The system comprises at least one interface configured to communicate with the clients and the servers, a memory that contains computer-readable and computer-executable instructions, and a processor coupled to the at least one interface and to the memory and configured to read and execute the instructions, the instructions being configured to cause the processor to: analyze a client-service communication, received from one of the clients by the at least one interface, for a client identifier associated with the client originating the client-service communication and for a virtual service identifier associated with an intended service of the client-service communication; perform network address translation on the client-service communication to produce a modified client-service communication, the translation including translating the virtual service identifier to an actual service identifier of the service and translating the client identifier to a virtual source identifier; and transmit the modified client-service communication via the at least one interface toward the intended service.

Implementations of the invention may include one or more of the following features. The virtual service identifier includes a virtual address and the actual service identifier includes an actual address and the instructions are configured to cause the processor to determine the actual address associated with the virtual address and to transmit the modified client-service communication with a destination address being the determined actual address. The virtual service identifier includes a virtual port number and the actual service identifier includes an actual port number and the instructions are configured to cause the processor to determine the actual port number associated with the virtual address and the virtual port number and to transmit the modified client-server communication with a destination port number being the determined actual port number. The memory further contains a pool of virtual source identifiers and the translation includes selecting the virtual source identifier from the pool of virtual source identifiers. The virtual source identifiers include pool addresses and the instructions are configured to cause the processor to transmit the modified client-server communication with a pool address as at least a portion of the virtual source identifier. The instructions are configured to cause the processor to associate client source information from the incoming client-server communication with one of the pool identifiers.

Implementations of the invention may also include one or more of the following features. The instructions are further configured to cause the processor to: analyze an incoming service-client communication, received from one of the servers by the at least one interface, for a virtual destination identifier and for a service source identifier associated with the server originating the server-client communication; perform network address translation on the service-client communication to produce a modified service-client communication, the translation including translating the virtual destination identifier to the client identifier and translating the service source identifier to the virtual service identifier; and transmit the modified server-client communication via the at least one interface toward the client. The memory further contains a pool of virtual source identifiers and the translation on the client-service communication includes selecting the virtual source identifier from the pool of virtual source identifiers and associating the client source identifier with the selected virtual source identifier and the translation on the service-client communication includes determining the client identifier by finding the identifier associated in the memory with the virtual destination identifier. The memory further contains stored relationships of virtual service identifiers and actual service identifiers and the instructions are configured to cause the processor to find one of the actual service identifiers that is associated with the virtual service identifier.

In general, in another aspect, the invention provides a method of conveying, via a network, communications between a client and a service. The method comprises receiving a client-to-service communication that is intended for the service, determining, from the client-to-service communication, an actual client identifier of the client and a virtual service identifier associated with an intended service for the client-to-service communication, producing a modified client-to-service communication by replacing the actual client identifier with a proxy source identifier and by replacing the virtual service identifier with an actual service identifier that is associated with the virtual service identifier, and transmitting the modified client-to-service communication toward the intended destination service according to the actual service identifier.

Implementations of the invention may include one or more of the following features. The client and service communicate in a communication session that includes a sequence of communications between the client and service, the method further comprising associating the proxy source identifier with the communication session. The actual source identifier includes a client address, the virtual service identifier includes a virtual address, the proxy source identifier includes a proxy address, the actual service identifier includes a server address, and the method further comprises storing the proxy address in association with the client address. The modified client-to-service communication is performed in a modification device and the client-to-service communication is a session-establishment communication, the method further comprising transmitting another communication from a source of the session-establishment communication to the service while bypassing the modification device. The client-to-service communication is a session-establishment communication, the method further comprising transmitting another communication from a source of the session-establishment communication to the service without replacing the actual client identifier. The method further comprises receiving a server-to-client communication that is intended for the client, determining, from the server-to-client communication, the actual service identifier and the proxy source identifier, producing a modified server-to-client communication by replacing the actual service identifier with the virtual service identifier and by replacing the proxy source identifier with the actual client identifier, and transmitting the modified server-to-client communication toward the client according to the actual client identifier.

Implementations of the invention may also include one or more of the following features. The method further comprises selecting the proxy source identifier from a pool of identifiers. The method further comprises associating the actual client identifier with the selected proxy source identifier. The method further comprises associating a different actual client with the selected proxy source identifier.

In general, in another aspect, the invention provides a communication system comprising a plurality of clients, a communication network coupled to the clients, with the clients are configured to communicate with the network, a plurality of servers coupled to the network and configured to communicate with the network and to provide managed and unmanaged services, and translation means for translating virtual service identifiers of communications from the clients to the servers requesting managed services to actual service identifiers that are associated with the requested managed services, and wherein communications from the clients to the servers requesting unmanaged services are communicated to the appropriate servers without conversion of virtual service identifiers to actual service identifiers.

Implementations of the invention may include one or more of the following features. The system of claim 19 wherein the translation means is configured to perform network address translation on the communications. The translation means is further for translating actual client identifiers of the communications from the clients to the servers requesting managed services to proxy source identifiers. The translation means is configured to select the proxy source identifier from a pool of identifiers and to associate a communication session between one of the clients and one of the services with the selected proxy source identifier. The translation means is for translating actual service identifiers of communications from the services to the clients responding regarding managed services to the associated virtual service identifiers and for translating selected proxy source identifiers in the communications from the services to the clients to the actual client identifiers associated with the communication sessions associated with the selected proxy source identifiers. The communication session is a first communication session and the translation means is configured to associate a second, different, communication session between one of the clients and one of the services with the selected proxy source identifier instead of the first communication session. The servers are database servers.

Various aspects of the invention may provide one or more of the following advantages. Network services may be provided selectively through a managing switch, and may be managed, e.g., by regulating access to the services, and/or by balancing loads associated with servers providing the services and/or loads associated with the services, etc. Managed services provided by a server may be accessed through a managing switch and non-managed services provided by the server accessed independently of the managing switch. Regardless of current network connections between clients and servers, a managing switch can be included anywhere in the network and managed services directed through the switch without changing the current connections. Network services can be managed using a relatively low bandwidth device, e.g., a Fast Ethernet router instead of a Gigabit router. Managed network services can be virtualized. Servers providing managed services may be added without physically connecting the servers to a managing device or altering the servers' network addresses. Managed services can be switched over a WAN that can, among other things, provide a solution for disaster recovery (DR) between a primary and a secondary site. Session establishment for managed services can be directed through a managing device while data provision communications for a session can bypass the managing device.

These and other advantages of the invention, along with the invention itself, will be more fully understood after a review of the following figures, detailed description, and claims.

### BRIEF DESCRIPTION OF THE FIGURES

FIG. 1 is a simplified diagram of a typical database network implementation.

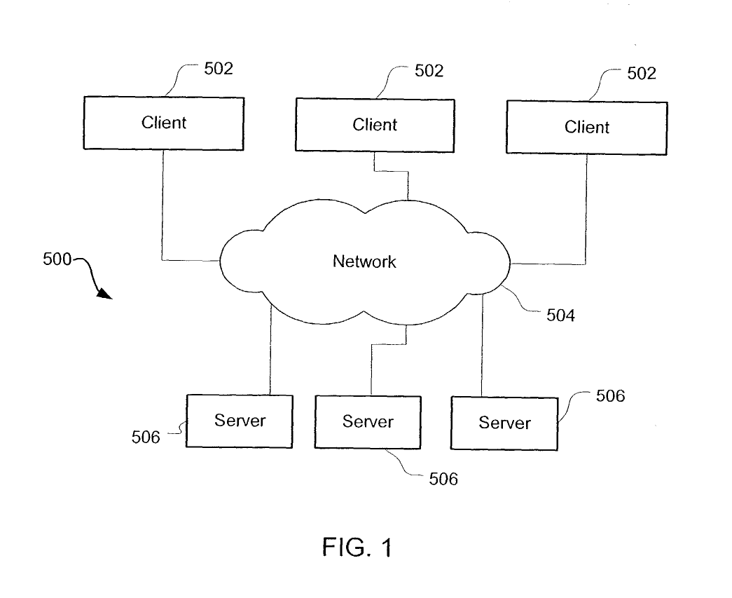

FIG. 2 is a simplified diagram of a network architecture including a switch configured to implement double network address translation.

FIGS. 3A-3B are simplified block diagrams of components of the switch shown in FIG. 2.

FIG. 4 is a list of virtual addresses and port numbers mapped to local addresses and port numbers, and a list mapping pool addresses and port numbers to client addresses and port numbers.

FIG. 5 is a block flow diagram of a process of selectively managing services using the network architecture shown in FIG. 2.

FIG. 6 is a simplified diagram of information flow from a client through a switch to a server, back through the switch to the client, and to another server and back to the client using the architecture shown in FIG. 2.

FIG. 7 is an example of a sequence of destination and source addresses and port numbers of information packets traveling through the network as shown in FIG. 6.

### DETAILED DESCRIPTION OF PREFERRED EMBODIMENTS

Some embodiments of the invention provide techniques for selectively managing network services while concealing network service identifiers associated with managed services. For example, a management system according to some embodiments of the invention can advertise in a network that the system supports various services and that the services are available at certain virtual service identifiers that include virtual network addresses and/or virtual port numbers. The system can translate the virtual identifiers of incoming communications destined for a service to actual service identifiers that include actual network addresses and actual port numbers of the services. The system can dynamically choose which of several servers that provide a desired service should receive the communication to begin a communication session between a client and a service. The system can also translate the source address and/or port number of a communication to a selected pool address and/or pool port number that the system associates with the session. The pool address and/or port number serve(s) as proxy information for the client for the session. Responses by the service include the actual server address and port number of the server providing the service, and the pool address and/or port number and the system translates these into the virtual identifier and the source address and port number. Thus, the system performs double NAT for communications between client and service in both directions. Information sent to the servers for unmanaged services (at least by the management system) or for managed services after session establishment (if the server provides the client with a server's actual address and port number) can bypass the management system and avoid translation of the source and destination identifiers/addresses. Other embodiments are within the scope of the invention.

As an example, the following description discusses database services and a database managing switch. The invention, however, is not limited to database servers, database managing switches, or database services as other types of servers, managing switches, and/or services are acceptable and within the scope of the invention. For example, the servers could be configured to provide any of a wide range of services such as web content, FTP, email, e-commerce, printing, graphics, audio and/or video services, etc.

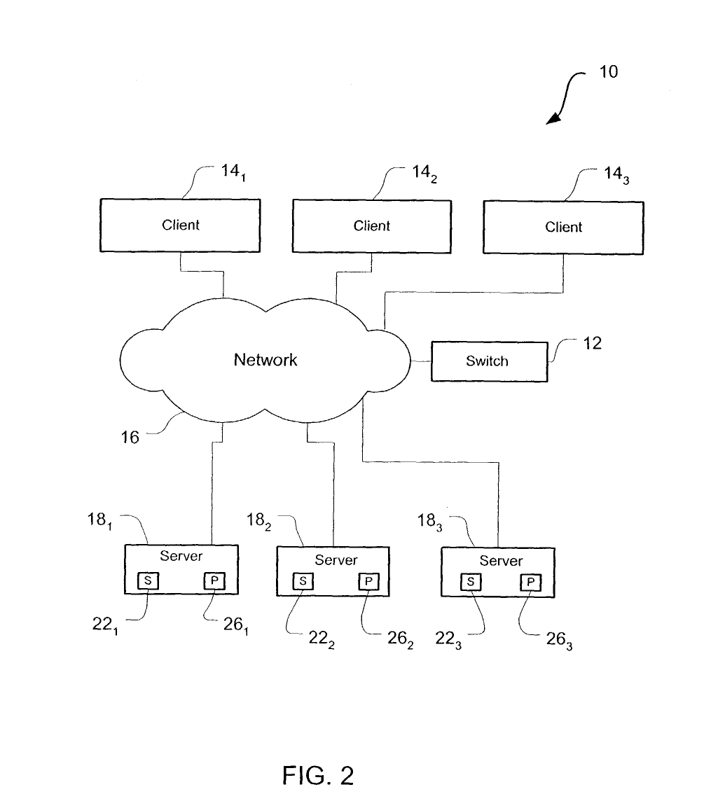

Referring to FIG. 2, a communication system 10 includes a database switch (switch) 12, three clients 14, a network 16, and three servers 18₁-18₃. While three clients 14 and three servers 18 are shown, the system 10 is scalable such that other quantities of the clients 14 and/or the servers 18 are possible and would be acceptable. If the servers 18 are database servers, then the switch 12 is a database switch (switch), and the system 10 includes storage for the servers 18 (shared storage and/or individual, local storage for the servers 18). As shown, the switch 12 is “on the side” in that communications between the clients 14 and the services provided by the servers 18 (or other servers) need not pass through the switch 12. The switch 12 can manage services in that it can operate on communications sent from/to the clients 14 toward/from services provided by the servers 18 in addition to relaying the communications, e.g., to regulate access to the services. The network 22 is preferably a packet-switched network such as a local area network (LAN), a wide area network (WAN), or the global packet-switched network commonly known as the Internet. Packets of data transferred in the system 10 include source and destination identifiers including addresses, e.g., Internet Protocol (IP) addresses, and port numbers.

The servers 18 store programs for providing various services. The servers 18 store databases and also store and perform database programs (called database instances for Oracle® servers) that are assigned to the various servers 18 for providing various database services. The servers 18 also store Database Management System (DBMS) software. The servers 18 include processors, e.g., CPUs, that are configured to perform tasks according to computer-readable and computer-executable software programs stored in association with the servers 18. The servers 18 are configured to send and receive information to and from the network 16 to communicate with the clients 14 either through the switch 12 or by bypassing the switch 12. Information exchanged among the clients 14, the network 16, the services of the servers 18 and the switch 12 is in the form of data packets that include source and destination addresses and source and destination port numbers.

Communications between the clients 14 and the servers 18 occur in sessions for obtaining the servers' services. Communication sessions may be one-phase sessions or two-phase sessions. In a one-phase session, the client 14 accesses an address and port number, that may be actual or virtual, and receives services in response. In a two-phase seesion, the client 14 accesses an address and port number (typically virtual) and receives an address and port number (either virtual or actual) from which the actual service will be supplied (and that may be for the same server). For example, using an Oracle® database service, the client 14 first accesses an Oracleg listener through a virtual IP address and port number. The listener returns an actual address and port number for a database instance that the client directly accesses using the actual address and port number to get the desired data of the service. For two-phase sessions, the two parts of the session may be performed by one of the servers 18 or by a combination of the servers 18. If the actual address is returned in a two-phase session, then only the first, session-establishment portion of the communications between the client 14 and the servers 18 can pass through the switch 12 and the second portion of the session can bypass the switch 12. This would not significantly impact the advantages of virtualization as the actual address and port number provided by the server 18 would not be easily detectable. Even in a two-phase communication, however, the second, data-providing portion may still pass through the switch 12, e.g., if the address and port number provided to the client 14 in the first phase are a virtual address managed by the switch 12.

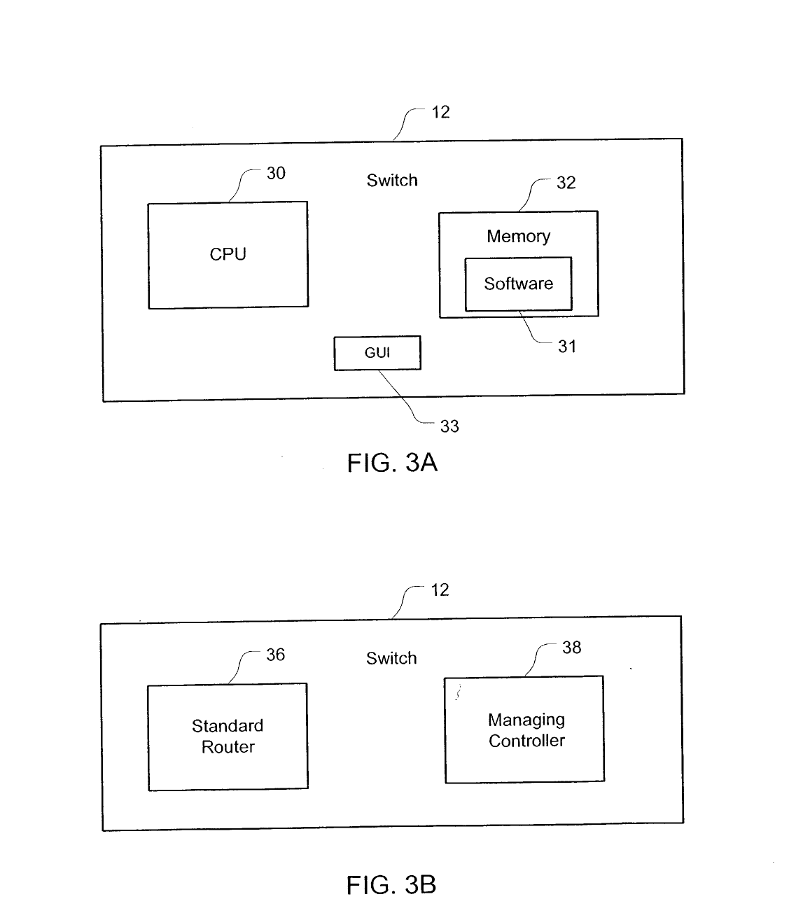

Referring also to FIG. 3B, the switch 12 includes a router 36 and a managing controller 38. As shown and preferred, the router 36 and the controller 38 are implemented as separate physical devices, but may be implemented as a single device. The following description refers to the router 36 and/or the controller 38 as the switch 12. The router 36 can perform typical router functions including network address translation (NAT) from virtual addresses to actual addresses and vice versa, routing of packets, and using access control lists (ACLs). The managing controller 38 is configured to control the router 36 to perform functions described below.

Referring to FIGS. 2, 3A, and 4, the switch 12 includes a processor 30, a memory 32, and an interface. The memory 32 stores computer-readable and computer-executable software instructions 31 to be executed and performed by the processor 30 to perform operations described below. The memory 32 also stores a list 40 that maps virtual service/destination addresses (e.g., virtual Internet Protocol (VIP) addresses) 42 to local network addresses 46 of the services (i.e., addresses used by the appropriate server 18). The interface 33 is a graphical user interface (GUI) configured to allow a user of the switch 12 to produce and modify the list 40. The list 40 may be dynamically updated by the user or the switch 12, e.g., to account for changing conditions in the system 10 such as whether particular servers 18 are up or down (operational/not operational), current server and/or service load, etc. The list 40 also maps virtual port numbers 44 to actual port numbers 48. While the port numbers 44, 46 of the mappings shown are different for each mapping (e.g., for use with servers that use default port numbers), the port numbers 44, 46 in any given mapping may be the same. The virtual addresses 42 and virtual port numbers 44 provide identifiers for the services being communicated with by the client 14. The memory 32 also stores a list 50 of pool addresses 52 and port numbers 54 and the processor 30 can execute stored instructions to pick an available pool address 52 and port number 54 to assign to a particular communication session to provide a virtual source identifier for the session. When a pool address is done being used (e.g., a client-service session ends), the pool address is returned to the pool and can be recycled/reused/reassigned for/to another communication session. The list 50 includes room for client addresses 56 and client port numbers 58 that get associated with the pool addresses 52 and pool port numbers 54. The list 50 can be produced and modified by the switch's user through the interface 33.

The switch 12 is configured to perform network address translation (NAT) on incoming communications (e.g., requests) from the clients 14 to services, and on outgoing communications (e.g., responses) from services to the clients 14. The switch 12 includes appropriate interfaces for communicating with the network 16 to communicate with the clients 14 and the servers 18. The switch 12 is configured to receive virtual identifiers including virtual destination addresses 44 and/or virtual port numbers 46 in service communications (e.g., requests and other communications, e.g., carrying data) from the clients 14 and to convert or map these virtual identifiers into the corresponding actual identifiers including actual addresses 44 and actual port numbers 48. The conversion can be a dynamic decision, e.g., based on current operational status of the servers 18, which servers 18 can provide a desired service, current server and/or service and/or system load, etc. The conversion can be performed in accordance with the stored list 40. The switch 12 can replace the actual address 46 for the virtual address 42, and the actual port number 48 for the virtual port number 44 as appropriate in the service identifier. The switch 12 can determine whether an address or port number is virtual or actual and replace it only if it is virtual. Alternatively, the switch 12 may replace all addresses/port numbers even though the replacement may be identical to the replaced value if the replaced value was an actual, and not virtual, address/port number. The switch 12 also replaces the actual source identifier (address and/or port number) with a virtual source identifier. The switch 12 selects an available pool address 52 and corresponding port number 54 and replaces the source address and source port number in the incoming communication with the selected pool address 52 and port number 54. The switch 12 is configured to forward the modified communication (with virtual destination identifier and source identifier replaced) to the network 16 for routing to the appropriate service. The switch 12 is configured to perform the opposite conversion in communications going from any one of the services toward any of the clients 14. Also, the switch 12 can be configured to convert only the virtual address or only the virtual the port number, or to selectively convert the virtual address and/or the virtual port number, e.g., depending upon the incoming communication (e.g., depending upon the incoming destination address and destination port number). Thus, both the virtual address and virtual port number could be replaced or only one of them, as determined on a case by case or other basis.

The switch 12 is configured to communicate with the network 22 to advertise virtual identifiers for corresponding services that are accessible through, and managed by, the switch 12. The switch 12 also advertises to the network 22 the pool address and port number combinations available through the switch 12 so that communications directed to the pool address/port number combinations (e.g., from the servers 18) will reach the switch 12. The switch 12 sends communications to the network 22 informing routers in the network 22 of the addresses/port numbers and services accessible through the switch 12.

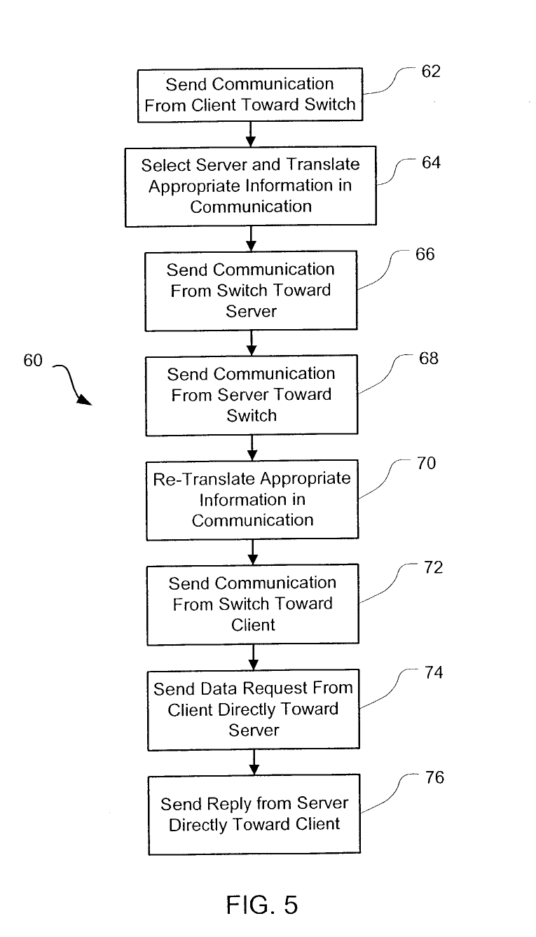

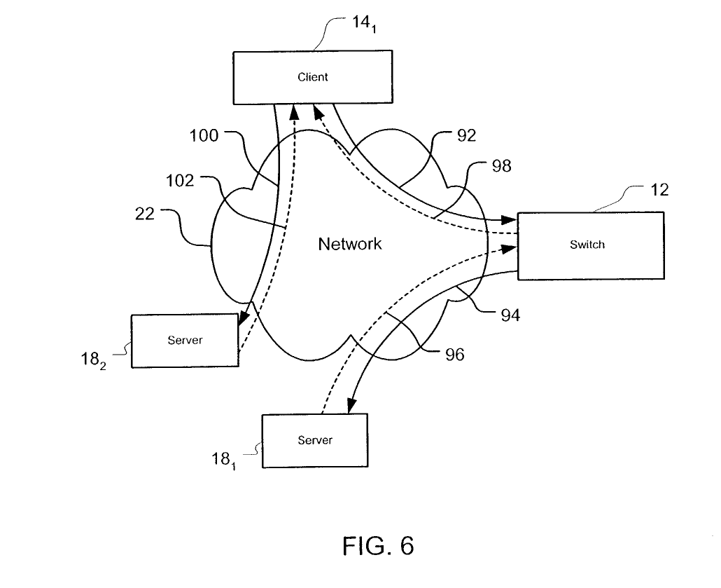

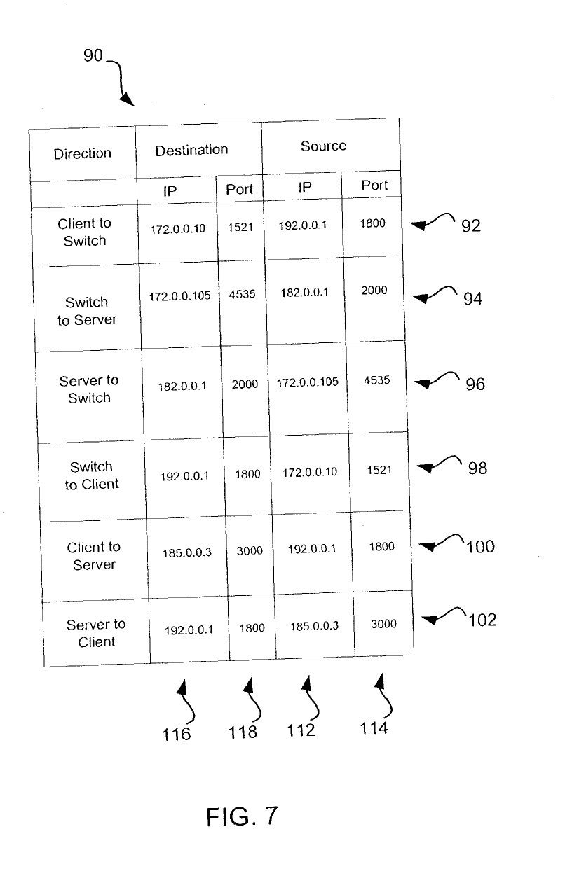

In operation, referring to FIGS. 5-7, with further reference to FIG. 2-4, a process 60 for providing managed services using the system 10 includes the stages shown. The process 60, however, is exemplary only and not limiting. The process 60 can be altered, e.g., by having stages added, removed, or rearranged. FIGS. 6-7 help to illustrate the process 60. FIG. 6 shows schematically the flow of communications between portions of the system 10 while FIG. 7 shows a table 90 of destination address and port numbers and source address and port numbers contained in communications between portions of the system 10.

At stage 62, one of the clients 14, e.g., the client 14₁, sends a session-establishment communication 92, toward the switch 12, that is intended for a service provided by at least one of the servers 18, e.g., the servers 18₁ and 18₂. For the communication 92, the source address 112 and the source port number 114 are those of the client 14₁ while the destination identifier of the destination address 116 and the destination port number 118 are the virtual address 42 and port number 44 corresponding to the desired service. The communication 92 will eventually reach the server 18₁ even though the communication 92 does not include, and the client 14₁ does not know, the address 46 and port number 48 of the server 18₁ for providing the desired service. This intention is implied by the destination address 116 and port number 118 values corresponding to virtual address 42 and port number 44 values that are associated with the local address 46 and port number 48 values of the server 18₁.

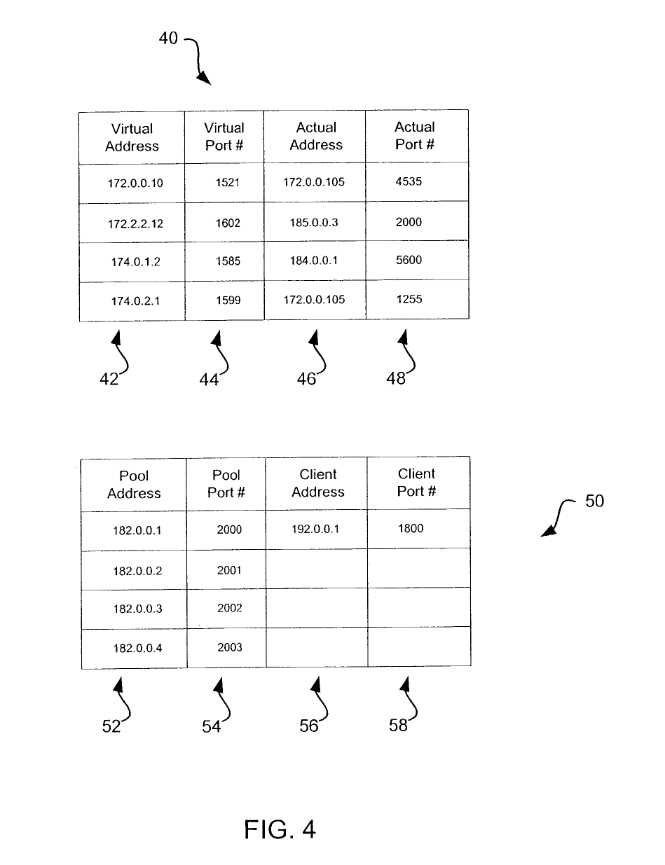

At stage 64, the switch 12 selects a server 18 for providing the desired service and translates the appropriate information in the communication 92. In this example, the switch 12 translates both the destination address 116 and the destination port number 118 to the actual address 46 and actual port number 48 corresponding to the appropriate virtual address 42 and virtual port number 44 values from the table 40 (FIG. 4). The associations of the table 40 dictate the selection of the server 18, here the server 18₁, for providing the desired service and receiving the session-establishment communication. The switch 12 could select the server 18 to use and translate the address 116 and/or port number 118 based on a dynamic decision (e.g., to help balance loads of the servers 18), including dynamically changing the table 40 for use in the translation. Further, the switch 12 identifies at least one available (currently unused/unassigned) pool address 52 and pool port number 54 from the table 50 (FIG. 4), i.e., with no associated client address 56 and port number 58. The switch 12 selects an available pool address 52 and pool port number 54 and replaces the actual source identifier (here, the actual source address 112 and the actual source port number 114) with the virtual source identifier of the selected pool address and port number values. The switch 12 also associates the selected pool address 52 and pool port number 54 with a communication session between the client 14₁ and the desired service by storing the client's address and port number for the communication 92 in the list 50 (FIG. 4). Here, all the pool addresses 52 and port numbers 54 were free (no associated client address and port number) and the switch 12 has selected the pool address 182.0.0.1 and the pool port number 2000. The switch has thus stored the address 192.0.0.1 and port number 1800 of the communication from the client 14₁ in association with the selected pool address 52 and port number 54 in the list 50.

At stage 66, the switch 12 sends a communication 94 from the switch 12 toward the server 18₁. For the communication 94, the source address 112 and port number 114 are the pool address 52 and port number 54 that replaced the address and port number of the client 14₁. Also, the destination address 116 and destination port number 118 are the actual address 46 and actual port number 48 values that replaced the virtual address 42 and virtual port number 44 values from the communication 92.

At stage 68, the server sends a response communication 96 toward the switch 12 intended for the client 14₁. The source address 112 and port number 114 of the communication 96 are the destination address 116 and port number 118 of the communication 94. Similarly, the destination address 116 and port number 118 of the communication 96 are the source address 112 and port number 114 of the communication 94. If the session is a two-phase session, then in the response communication 94, the server 18₁ provides an actual address and port number (185.0.0.3, 2000) of the server, here the server 18₂, that will perform the data-providing portion of the service. If the same server 18₁ will perform both aspects of the service (establishment and data providing), then the response 96 includes the actual address and port number of the server 18₁. If the session is a one-phase session, then the response 94 includes data for the service.

At stage 70, the switch 12 receives the communication 96 and translates the appropriate information for sending a communication toward the client 14₁. Here, the switch 12 translates the source and destination addresses 112, 116 and the source and destination port numbers 114, 118. The switch 12 finds the actual address 46 and port number 48 in the list 40 and uses the associated virtual address 42 and port number 44 for the source address 116 and port number 118 to produce a communication 98. The switch 12 also finds the (virtual source) pool address 52 and port number 54 in the list 50 and uses the associated client address 56 and port number 58 for the destination address 112 and port number 114 to produce the communication 98.

At stage 72, the switch 12 sends the communication 98 toward the client 14₁ using the re-translated values. The communication 98 includes whatever data the server 18₁ desired the client 14₁ to receive. For a two-phase session, these data are for communication session establishment such that the client 14₁ will proceed to complete communication setup. These data may, however, be data for the service if the session is a one-phase session. The client 14₁, seeing that the source address 112 and port number 114 in the communication 98 correspond to the destination address 116 and port number 118 of the communication 92, will associate the communication 98 with a corresponding client-service interaction/session and process the content of the communication 98 accordingly.

At stage 74, the client 14₁ sends a communication 100 to receive data for the desired service. Here, the communication 100 is for a two-phase session and is directed to the server 18, here the server 182, that will perform the data-providing portion of the service. As shown, because the server 18₁ provided the actual address and port number for the server 182, the communication 100 bypasses the switch 12 and proceeds through the network 22 to the server 18₂. The communication 100 would also bypass the switch 12 if the server 18₁ performs both portions of the service and had provided its own actual address and port number in the response communication 96. Thus, these communications are not modified by the switch, e.g., having the actual client identifier replaced by a proxy identifier. Further communication between the server 18₂ and the client 14₁ continues as appropriate for providing/receiving data related to the service.

At stage 76, the server 182 sends a response communication 102 directly to the client 14₁, bypassing the switch 12. The response 102 replies to the communication 100 from the client 14₁ and supplies information for the service desired by the client 14₁ as indicated in the communication 92. For the communication 102, the source address and port number are those of the server 18₂, and are the destination address and port number of the communication 100. Likewise, the destination address and port number are those of the client 14₁, and are the source address and port number of the communication 100 from the client 14₁.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. For example, functions described above as being performed by the switch 12 could be performed elsewhere in the system 10, e.g., in the clients 14 and/or the servers 18 and/or the network 22. Thus, the functions described above as being performed by the switch 12 could be implemented in a distributed manner in the system 10, with different functions being performed at different physical locations in the system 10. The conversions of virtual identifiers to actual identifiers and vice versa could be performed in the clients 14, and/or the servers 18, and/or portions of the network 22. In at least such cases, the switch 12 could be eliminated as a separate entity in the system 10. Also, the switch 12 may be separated into multiple physical components, e.g., an OSI layer-3 router and an OSI layer-2 switch. Further, as stated above, the invention is not limited to use with databases and database servers. Servers providing services other than database services are equally acceptable and within the scope of the invention. Also, the response communication 96 from the server 18₁ need not include the actual address and port number for the server 18 that is to perform the data-providing portion of the service. A virtual address and/or port number could be provided, or no address or port number provided, e.g., if the same server 18 will perform both portions of the service and all communications will flow through the switch 12.

What is claimed is:

1. A system for use in a network that includes a plurality of clients and a plurality of servers configured to provide services, the system comprising:
at least one interface configured to communicate with the clients and the servers;
a memory that contains computer-readable and computer-executable instructions; and
a processor coupled to the at least one interface and to the memory and configured to read and execute the instructions, the instructions being configured to cause the processor to:
analyze a client-service communication, received from one of the clients by the at least one interface, for a client identifier associated with the client originating the client-service communication and for a virtual service identifier associated with an intended service of the client-service communication;
perform network address translation on the client-service communication to produce a modified client-service communication, the translation including translating the virtual service identifier to an actual service identifier of the service and translating the client identifier to a virtual source identifier; and
transmit the modified client-service communication via the at least one interface toward the intended service.

2. The system of claim 1 wherein the virtual service identifier includes a virtual address and the actual service identifier includes an actual address and the instructions are configured to cause the processor to determine the actual address associated with the virtual address and to transmit the modified client-service communication with a destination address being the determined actual address.

3. The system of claim 2 wherein the virtual service identifier includes a virtual port number and the actual service identifier includes an actual port number and the instructions are configured to cause the processor to determine the actual port number associated with the virtual address and the virtual port number and to transmit the modified client-server communication with a destination port number being the determined actual port number.

4. The system of claim 1 wherein the memory further contains a pool of virtual source identifiers and the translation includes selecting the virtual source identifier from the pool of virtual source identifiers.

5. The system of claim 4 wherein the virtual source identifiers include pool addresses and the instructions are configured to cause the processor to transmit the modified client-server communication with a pool address as at least a portion of the virtual source identifier.

6. The system of claim 4 wherein the instructions are configured to cause the processor to associate client source information from the incoming client-server communication with one of the pool identifiers.

7. The system of claim 1 wherein the instructions are further configured to cause the processor to:
analyze an incoming service-client communication, received from one of the servers by the at least one interface, for a virtual destination identifier and for a service source identifier associated with the server originating the server-client communication;
perform network address translation on the service-client communication to produce a modified service-client communication, the translation including translating the virtual destination identifier to the client identifier and translating the service source identifier to the virtual service identifier; and
transmit the modified server-client communication via the at least one interface toward the client.

8. The system of claim 7 wherein the memory further contains a pool of virtual source identifiers and the translation on the client-service communication includes selecting the virtual source identifier from the pool of virtual source identifiers and associating the client source identifier with the selected virtual source identifier and the translation on the service-client communication includes determining the client identifier by finding the identifier associated in the memory with the virtual destination identifier.

9. The system of claim 1 wherein the memory further contains stored relationships of virtual service identifiers and actual service identifiers and the instructions are configured to cause the processor to find one of the actual service identifiers that is associated with the virtual service identifier.

10. A method of conveying, via a network, communications between a client and a service, the method comprising:
receiving a client-to-service communication that is intended for the service;
determining, from the client-to-service communication, an actual client identifier of the client and a virtual service identifier associated with an intended service for the client-to-service communication;
producing a modified client-to-service communication by replacing the actual client identifier with a proxy source identifier and by replacing the virtual service identifier with an actual service identifier that is associated with the virtual service identifier; and
transmitting the modified client-to-service communication toward the intended destination service according to the actual service identifier.

11. The method of claim 10 wherein the client and service communicate in a communication session that includes a sequence of communications between the client and service, the method further comprising associating the proxy source identifier with the communication session.

12. The method of claim 11 wherein the actual source identifier includes a client address, the virtual service identifier includes a virtual address, the proxy source identifier includes a proxy address, the actual service identifier includes a server address, and the method further comprises storing the proxy address in association with the client address.

13. The method of claim 10 wherein the modified client-to-service communication is performed in a modification device and the client-to-service communication is a session-establishment communication, the method further comprising transmitting another communication from a source of the session-establishment communication to the service while bypassing the modification device.

14. The method of claim 10 wherein the client-to-service communication is a session-establishment communication, the method further comprising transmitting another communication from a source of the session-establishment communication to the service without replacing the actual client identifier.

15. The method of claim 10 further comprising:
receiving a server-to-client communication that is intended for the client;
determining, from the server-to-client communication, the actual service identifier and the proxy source identifier;
producing a modified server-to-client communication by replacing the actual service identifier with the virtual service identifier and by replacing the proxy source identifier with the actual client identifier; and
transmitting the modified server-to-client communication toward the client according to the actual client identifier.

16. The method of claim 10 further comprising selecting the proxy source identifier from a pool of identifiers.

17. The method of claim 16 further comprising associating the actual client identifier with the selected proxy source identifier.

18. The method of claim 17 further comprising associating a different actual client with the selected proxy source identifier.

19. A communication system comprising:
a plurality of clients;
a communication network coupled to the clients, with the clients are configured to communicate with the network;
a plurality of servers coupled to the network and configured to communicate with the network and to provide managed and unmanaged services; and
translation means for translating virtual service identifiers of communications from the clients to the servers requesting managed services to actual service identifiers that are associated with the requested managed services;
wherein communications from the clients to the servers requesting unmanaged services are communicated to the appropriate servers without conversion of virtual service identifiers to actual service identifiers.

20. The system of claim 19 wherein the translation means is configured to perform network address translation on the communications.

21. The system of claim 19 wherein the translation means is further for translating actual client identifiers of the communications from the clients to the servers requesting managed services to proxy source identifiers.

22. The system of claim 21 wherein the translation means is configured to select the proxy source identifier from a pool of identifiers and to associate a communication session between one of the clients and one of the services with the selected proxy source identifier.

23. The system of claim 22 wherein the translation means is for translating actual service identifiers of communications from the services to the clients responding regarding managed services to the associated virtual service identifiers and for translating selected proxy source identifiers in the communications from the services to the clients to the actual client identifiers associated with the communication sessions associated with the selected proxy source identifiers.

24. The system of claim 22 wherein the communication session is a first communication session and the translation means is configured to associate a second, different, communication session between one of the clients and one of the services with the selected proxy source identifier instead of the first communication session.

25. The system of claim 19 wherein the servers are database servers.
